(19) United States
(12) Patent Application Publication
(10) Pub. No.: US 2011/0280482 A1
(43) Pub. Date: Nov. 17, 2011

(54) IMAGE DATA EXPANSION APPARATUS, IMAGE DATA COMPRESSION APPARATUS AND METHODS OF CONTROLLING OPERATION OF SAME

(75) Inventor: Shunichiro NONAKA, Tokyo (JP)

(73) Assignee: Fujifilm Corporation, Tokyo (JP)

(21) Appl. No.: 13/104,292

(22) Filed: May 10, 2011

(30) Foreign Application Priority Data
May 14, 2010 (JP) 2010-111626

(51) Int. Cl. G06K 9/36; G06K 9/34

(52) U.S. Cl. 382/180; 382/232; 382/173; 382/233

(57) ABSTRACT

A portion of an image that has been compressed is displayed promptly. To achieve this, an image is divided into a number of units and an RST marker is inserted into a unit every ten units. The image is compressed and recorded unit by unit. In a case where an area which is a portion of the image is displayed, the image data of all units of the original data is not expanded. Rather, units in which the image data is to be expanded are decided utilizing the RST markers. Only the image data of the units decided is expanded.

### BACKGROUND OF THE INVENTION

1. Field of the Invention

This invention relates to an image data expansion apparatus, an image data compression apparatus and methods of controlling the operation thereof.

2. Description of the Related Art

It has become common for image data to be viewed on a mobile telephone. The size of the display screen on a monitor that has been connected to a personal computer and the size of the display screen of a mobile telephone are different. In a case where an image having a size suitable for display on the display screen of a monitor that has been connected to a personal computer is displayed on the display screen of a mobile telephone, therefore, the image is reduced in size (see the specification of Japanese Patent Application Laid-Open No. 2006-60540). However, reducing image size indiscriminately and displaying the reduced image on the display screen of a mobile telephone sometimes results in an image which is too small and, contrary to what was intended, difficult to view. A conceivable approach in such case is to cut out a portion of the image and display the cut-out image portion on the display screen of the mobile telephone. However, if, in a case where a partial image portion is to be displayed, the original image data has been compressed, expanding the image takes time and it can take considerable time to display the partial image portion.

### SUMMARY OF THE INVENTION

An object of the present invention is to display a portion of an image comparatively quickly.

An image data compression apparatus according to a first aspect of the present invention comprises: a designating device (designating means) for designating a portion of an image, which is to be extracted, from within an original image; a compressed image data reading device (compressed image data reading means) for reading compressed image data from a recording medium on which the compressed image data has been recorded, the compressed image data having been obtained by dividing original image data representing the original image into a plurality of units, inserting identification data into any unit of the plurality of units and compressing, on a per-unit basis, the original data of any units of the units into which the identification data has been inserted and units into which the identification data has not been inserted, the compressed image data being read from the recording medium on a per-unit basis in accordance with a certain order; a first determination device (first determination means) for determining, based upon the portion of the image designated by the designating device, whether a unit of compressed image data that has been read by the compressed image data reading device contains the identification data; a second determination device (second determination means) for determining whether the portion of the image designated by the designating device is included between a unit determined by the first determination device to contain identification data and a unit that contains the next identification data; and an expanding device (expanding means), responsive to a determination by the second determination device that the portion of the image designated by the designating device is included between a unit determined by the first determination device to contain identification data and a unit that contains the next identification data, for expanding compressed image data which extends from the unit of compressed image data that has been read by the compressed image data reading device to the unit that contains the next identification data.

The first aspect of the present invention also provides an operation control method suited to the above described image data expansion apparatus. Specifically, the first aspect of the present invention provides a method of controlling operation of an image data expansion apparatus, comprising the steps of: designating a portion of an image, which is to be extracted, from within an original image; reading compressed image data from a recording medium on which the compressed image data has been recorded, the compressed image data having been obtained by dividing original image data representing the original image into a plurality of units, inserting identification data into any unit of the plurality of units and compressing, on a per-unit basis, the original data of any units of the units into which the identification data has been inserted and units into which the identification data has not been inserted, the compressed image data being read from the recording medium on a per-unit basis in accordance with a certain order; determining, based upon the portion of the image designated, whether a unit of compressed image data that has been read contains identification data; determining whether the portion of the image designated is included between a unit determined to contain identification data and a unit that contains the next identification data; and in response to a determination that the portion of the image designated is included between a unit determined to contain identification data and a unit that contains the next identification data, expanding the compressed image data from the unit of compressed image data that has been read to the unit that contains the next identification data.

The first aspect of the present invention further provides a recording medium storing a computer-readable program suited to the above-described method of controlling operation of the image data expansion apparatus. It may be so arranged that the program is provided.

In accordance with the first aspect of the present invention, it is determined whether a designated portion of an image is included between a unit of compressed image data read from a recording medium and a unit containing identification data that follows identification data contained in the first-mentioned unit. If it is determined that the designated portion of the image is included between the two units, then the compressed image data from the first-mentioned unit the unit containing the next identification data is expanded. Since only compressed data of the portion necessary to display the designated portion of the image is expanded, the designated portion of the image can be displayed at a comparatively high speed.

The above-mentioned identification data is an RST marker, by way of example.

A second aspect of the present invention generates compressed image data that is expanded in the image data expansion apparatus of the first aspect of the present invention described above. Specifically, the second aspect of the present invention provides an image data compression apparatus comprising: a unit dividing device (unit dividing means) for dividing original image data representing one frame of an original image into a plurality of units; an identification data insertion determination device (identification data insertion determination means) for determining whether to insert identification data into one unit among the plurality of units obtained by division by the unit dividing device; an identification data inserting device (identification data inserting means), responsive to a determination by the identification data insertion determining device of a unit into which identification data is to be inserted, for inserting the identification data into the unit determined; a compressing device (compressing means) for compressing original image data of the unit into which identification data has been inserted by the identification data inserting device or of a unit determined by the identification data insertion determination device to be one into which identification data is not to be inserted; a control device (control means) for exercising control in such a manner that operations performed by the identification data insertion determination device, identification data inserting device and compressing device are repeated; and a recording control device (recording control means) for recording image data, which has been compressed by the compressing device, on a recording medium.

The second aspect of the present invention also provides an operation control method suited to the above-described image data compression apparatus. Specifically, the second aspect of the present invention provides a method of controlling operation of an image data compression apparatus, comprising the steps of: dividing original image data representing one frame of an original image into a plurality of units; determining whether to insert identification data into one unit among the plurality of units obtained by division; in response to determination of a unit into which identification data is to be inserted, inserting the identification data into the unit determined; compressing original image data of the unit into which identification data has been inserted or of a unit determined to be one into which identification data is not to be inserted; exercising control in such a manner that operations performed by the identification data insertion determination processing, identification data inserting processing and compressing processing are repeated; and recording compressed image data on a recording medium.

The second aspect of the present invention further provides a recording medium storing a computer-readable program for implementing the above-described method of controlling operation of the image data compression apparatus. It may be so arranged that the program is provided.

In accordance with the second aspect of the present invention, compressed image data that can be expanded by the first aspect of the present invention and a portion of which can be displayed comparatively quickly can be recorded on a recording medium.

By way of example, the compressing device includes: an orthogonal transform device (orthogonal transform means) for applying an orthogonal transform to image data of a unit into which identification data has been inserted by the identification data inserting device or of a unit determined by the identification data insertion determination device to be one into which identification data is not to be inserted, and obtaining orthogonal transform coefficients; and an encoding device (encoding means) for assigning a prescribed code to each of the orthogonal transform coefficients obtained by the orthogonal transform device and obtaining encoded data.

An image data compression apparatus according to a third aspect of the present invention comprises: a designating device (designating means) for designating a portion of an image, which is to be extracted, from within an original image; a compressed image data reading device (compressed image data reading means) for reading compressed image data from a recording medium on which the compressed image data has been recorded, the compressed image data having been obtained by dividing original image data representing the original image into a plurality of units and compressing the original image data on a per-unit basis, address data indicating a start address of each unit of the plurality of units also having been recorded on the recording medium, the compressed image data being read from the recording medium on a per-unit basis; an address data reading device (address data reading means) for reading the address data from the recording medium; a determination device (determination means) for determining, based upon the portion of the image designated by the designating device and the address data read by the address data reading device, whether the portion of the image designated by the designating device is included between a unit of compressed image data that has been read by the compressed image data reading device and the next unit; and an expanding device (expanding means), responsive to a determination by the determination device that the portion of the image designated by the designating device is included between a unit of compressed image data that has been read by the compressed image data reading device and the next unit, for expanding compressed image data which extends from the unit of compressed image data that has been read by the compressed image data reading device to the next unit.

The third aspect of the present invention also provides an operation control method suited to the above described image data expansion apparatus. Specifically, the third aspect of the present invention provides a method of controlling operation of an image data expansion apparatus, comprising the steps of: designating a portion of an image, which is to be extracted, from within an original image; reading compressed image data from a recording medium on which the compressed image data has been recorded, the compressed image data having been obtained by dividing original image data representing the original image into a plurality of units and compressing the original image data on a per-unit basis, address data indicating a start address of each unit of the plurality of units also having been recorded on the recording medium, the compressed image data being read from the recording medium on a per-unit basis; reading the address data from the recording medium; determining, based upon the portion of the image designated and the address data read, whether the portion of the image designated is included between a unit of compressed image data that has been read and the next unit; and in response to a determination that the portion of the image designated is included between a unit of compressed image data that has been read and the next unit, expanding compressed image data which extends from the unit of compressed image data that has been read to the next unit.

The third aspect of the present invention further provides a recording medium storing a computer-readable program for implementing the above-described method of controlling operation of the image data expansion apparatus. It may be so arranged that the program is provided.

In the third aspect of the present invention as well, it is determined whether a designated portion of an image is included between a unit of compressed image data read from a recording medium and a unit containing identification data that follows identification data contained in the first-mentioned unit. If it is determined that the designated portion of the image is included between the two units, then the compressed image data from the first-mentioned unit to the unit containing the next identification data is expanded. Since only compressed data of the portion necessary to display the designated portion of the image is expanded, the designated portion of the image can be displayed at a comparatively high speed.

A fourth aspect of the present invention generates compressed image data that is expanded in the image data expansion apparatus of the third aspect of the present invention described above. Specifically, the fourth aspect of the present invention provides an image data compression apparatus comprising: a unit dividing device (unit dividing means) for dividing original image data representing one frame of an original image into a plurality of units; a compressing device (compressing means) for compressing one frame of original image data of each unit among the plurality of units obtained by division by the unit dividing device; and a recording control device (recording control means) for recording address data indicating a start address of any unit among the plurality of units obtained by division by the unit dividing device, as well as image data compressed by the compressing device, on a recording medium.

The fourth aspect of the present invention also provides an operation control method suited to the above-described image data compression apparatus. Specifically, the fourth aspect of the present invention provides a method of controlling operation of an image data compression apparatus, comprising the steps of: dividing original image data representing one frame of an original image into a plurality of units; compressing one frame of original image data of each unit among the plurality of units obtained by division; and recording address data indicating a start address of any unit among the plurality of units obtained by division, as well as compressed image data, on a recording medium.

The fourth aspect of the present invention further provides a recording medium storing a computer-readable program for implementing the above-described method of controlling operation of the image data compression apparatus. It may be so arranged that the program is provided.

In accordance with the fourth aspect of the present invention, compressed image data that can be expanded by the third aspect of the present invention and a portion of which can be displayed comparatively quickly can be recorded on a recording medium.

By way of example, the compressing device includes: an orthogonal transform device (orthogonal transform means) for applying an orthogonal transform to original image data of each unit and obtaining orthogonal transform coefficients; and an encoding device (encoding means) for assigning a prescribed code to each of the orthogonal transform coefficients obtained by the orthogonal transform device and obtaining encoded data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an overview of a data communication system;

FIG. 2 is a block diagram illustrating the electrical configuration of an image storage server;

FIG. 3 is an example of an image;

FIG. 4 is an example of an image file structure;

FIG. 5 is a flowchart illustrating data compression processing;

FIG. 6 is an example of an image;

FIG. 7 is an example of an image file structure;

FIG. 8 is an example of an image;

FIGS. 9 and 10 are examples of image file structures;

FIG. 11 is a correspondence table of correspondence between DCT coefficients and Huffman codes;

FIG. 12 illustrates the corresponding relationship between Huffman codes and DCT coefficients;

FIG. 13 is a flowchart illustrating processing executed by a mobile telephone and image storage server;

FIG. 14 is an example of an image;

FIG. 15 is a flowchart illustrating data compression processing;

FIG. 16 illustrates the corresponding relationship between unit numbers and start addresses; and

FIG. 17 is a flowchart illustrating processing executed by a mobile telephone and image storage server.

### DESCRIPTION OF THE PREFERRED EMBODIMENTS

Preferred embodiments of the present invention will now be described in detail with reference to the drawings.

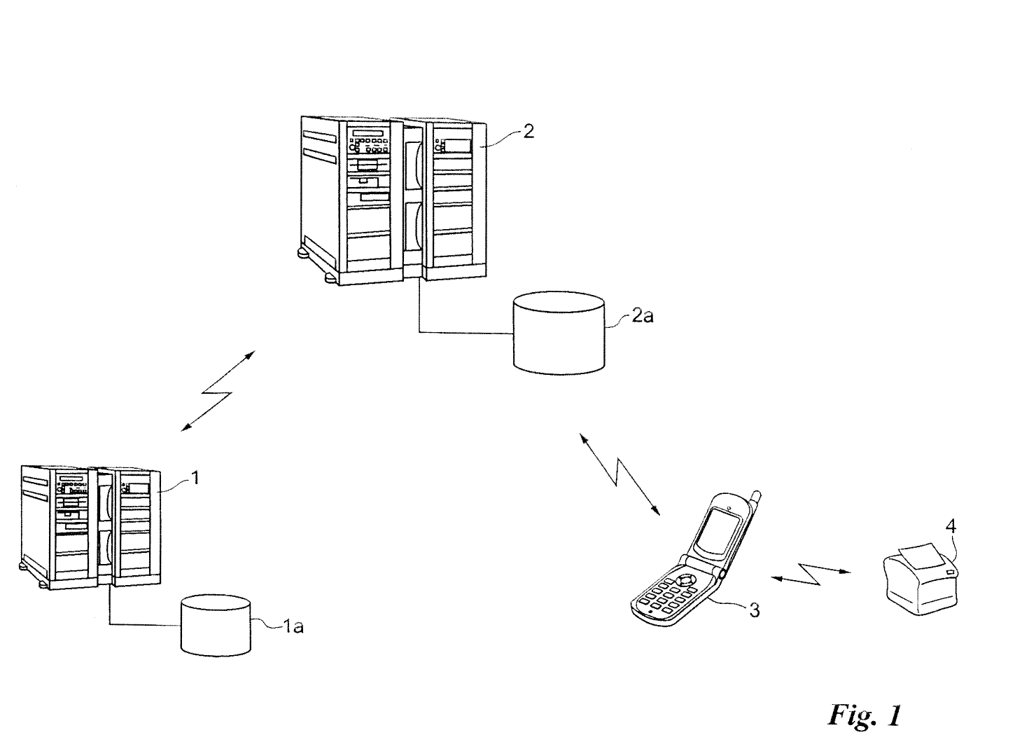

FIG. 1 illustrates an overview of an image data communication system according to a preferred embodiment of the present invention.

The image data communication system includes an image storage server 1, an image transmission server 2, a mobile telephone 3 and a printer 4. A hard disk 1a storing a number of items of image data is connected to the image storage server 1. A hard disk 2a storing a number of items of image data is connected to the image transmission server 2 as well.

When the mobile telephone 3 requests the image transmission server 2 for image data, the request is transferred from the image transmission server 2 to the image storage server 1. Image data conforming to the request is read from the hard disk 1a at the image storage server 1. The read image data is transmitted from the image storage server 1 to the image transmission server 2. The image data is then transmitted from the image transmission server 2 to the mobile telephone 3. The image represented by the requested image data is displayed on the display screen of the mobile telephone 3. The image data is transmitted from the mobile telephone 3 to the printer 4, which proceeds to print the image.

The image data that has been stored on the hard disk 1a of the image storage server 1 is high-quality image data and is suited to a case where an image is displayed on a display device having a comparatively large screen. However, since the display screen of the mobile telephone 3 is small, there are instances where displaying the full image will result in a display that is difficult to view. In this embodiment, a portion of an image is displayed on the display screen of the mobile telephone 3.

An operation program for executing processing (described later) has been stored in a CD-ROM (Compact Disk-Read-Only Memory) 5. The operation program is read out of the CD-ROM 5 and installed in the image storage server 1. Naturally, it may be so arranged that the operation program is applied to the image storage server 1 via a network.

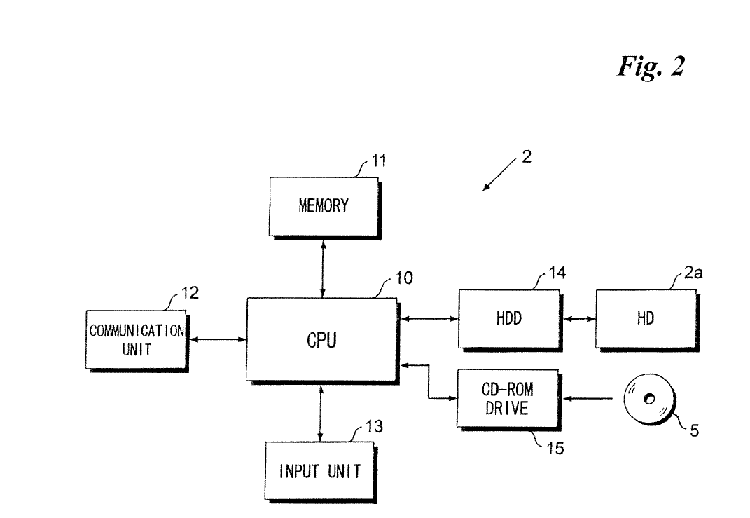

FIG. 2 is a block diagram illustrating the electrical configuration of the image storage server 1.

The overall operation of the image storage server 1 is controlled by a CPU 10.

The image storage server 1 includes a memory 11 for storing various data temporarily; a communication unit 12 for communicating with the image transmission server 2; an input unit 13 such as a keyboard; and a hard-disk drive 14 for accessing the hard disk 1a.

The image storage server 1 further includes a CD-ROM drive 15 for accessing the CD-ROM 5.

The image transmission server 2 has a configuration similar to that of the image storage server 1. Further, the mobile telephone 3 also has an internal CPU that makes it possible to execute processing (described later) for cutting out an image. It goes without saying that the mobile telephone 3 is provided with a communication unit for communicating with the image transmission server 2, a keyboard, a circuit for sending and receiving voice, an antenna, a microphone and a speaker, etc.

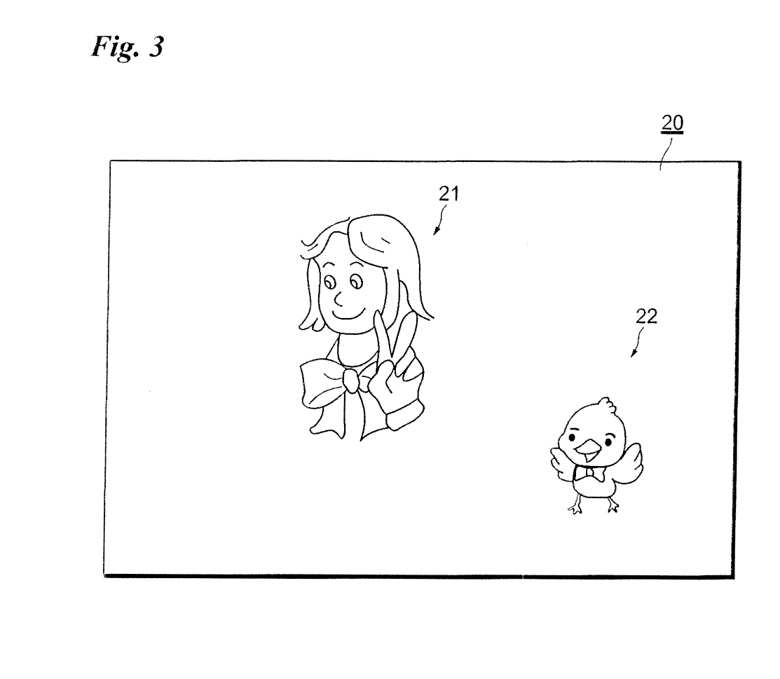

FIG. 3 is an example of an image 20.

The image 20 includes images 21 and 22 of subjects. As will be described later, it is assumed that such an image 20 is subjected to image data compression processing in the image storage server 1.

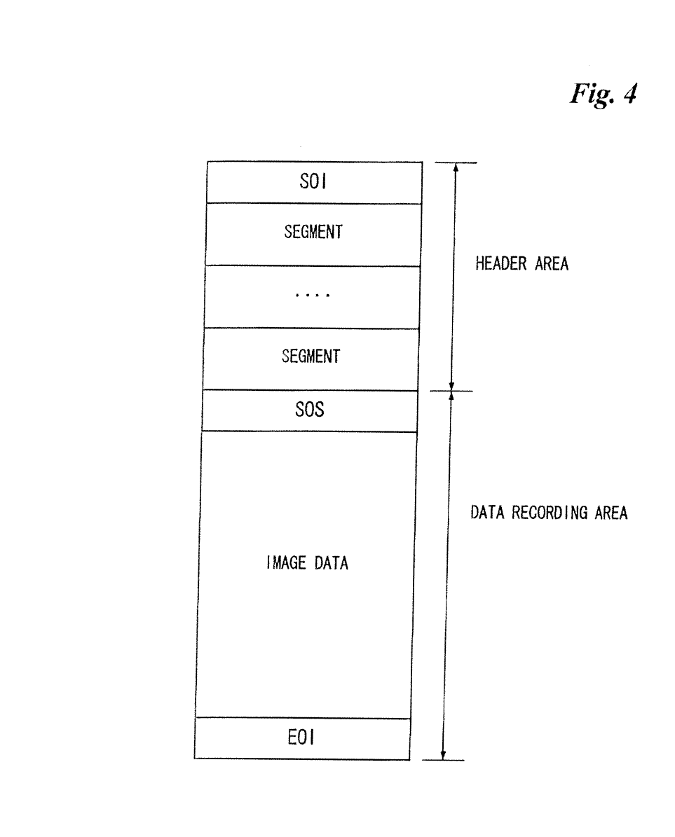

FIG. 4 is an example of the file structure (data structure) of an image file.

This image file represents the image 20 shown in FIG. 3.

The image file includes a header area and a data recording area.

The header area extends from an SOI (start of image) marker to the beginning of an SOS (start of scan) marker. Image-file management data is stored in the header area, which has been divided into a plurality of segments. The management data has been stored in the segments.

The data recording area extends from the SOS marker to EOI (end of image). Image data representing an image is stored in the data recording area.

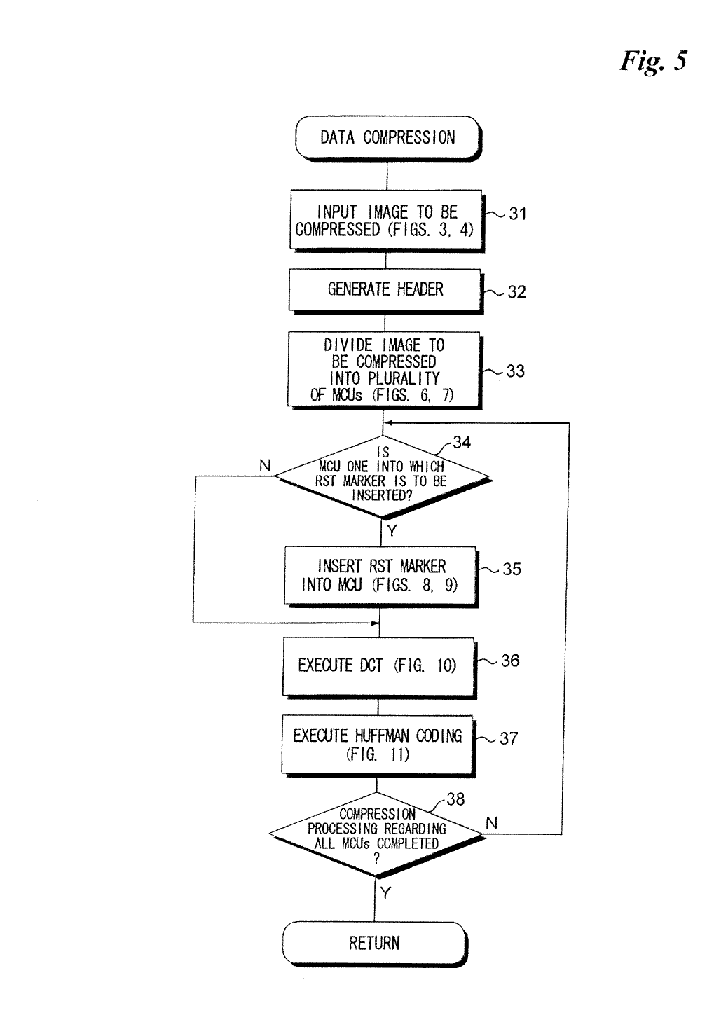

FIG. 5 is a flowchart illustrating image data compression processing executed in the image storage server 1. Image data compression processing is not limited to the image storage server 1 and may be executed in the image transmission server 2 or mobile telephone 3.

It is assumed that the image data representing the image 20 shown in FIG. 3 will be compressed.

The image data representing the image to be compressed is read from the hard disk 1a and input to the image storage server 1 (step 31). If a header has not yet been generated, then the header of the image file for this image is generated (step 32).

The image represented by the read image data is divided into a plurality of MCUs (minimum coded units) (step 33).

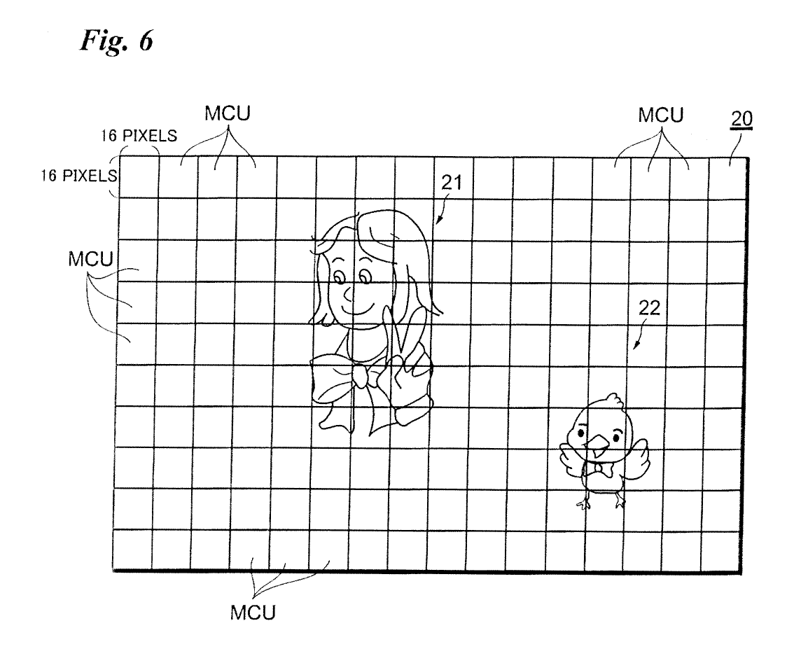

FIG. 6 illustrates the image 20 divided into a plurality of MCUs. The image 20 has been divided into a number of MCUs in which each single MCU is composed of 16×16 pixels (8×8 pixels is permissible as well).

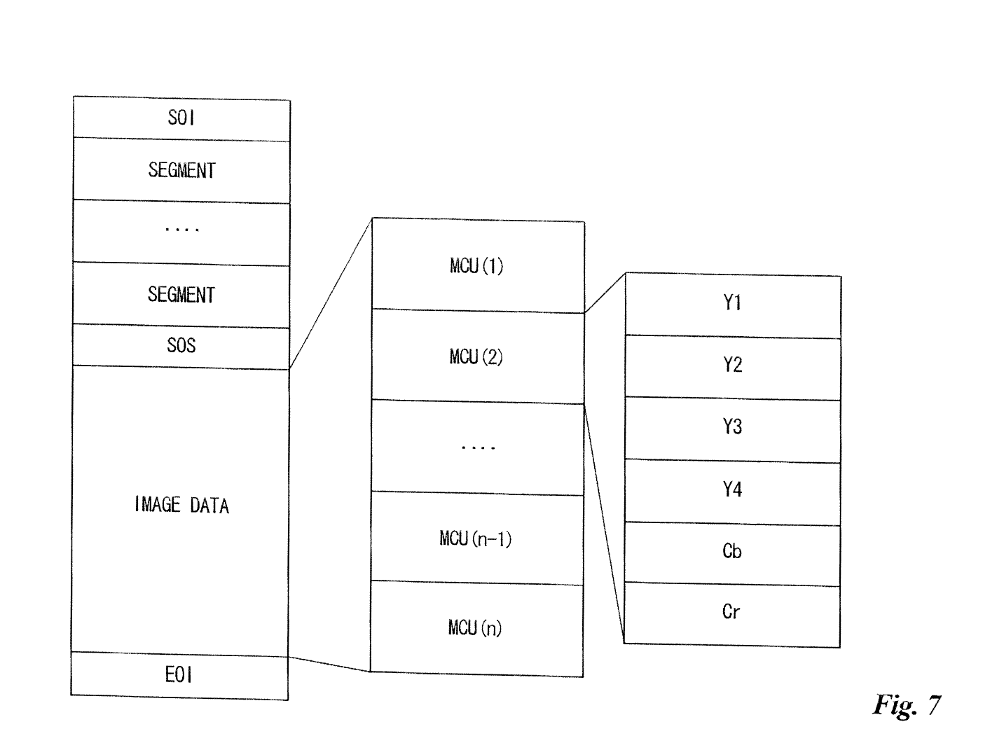

FIG. 7 illustrates an example of the file structure of the image file representing the image 20 that has been divided into a number of MCUs.

The image data that has been recorded in the data recording area has been divided into n-number of MCUs, as mentioned above. Each of the n-number of MCUs contains image data representing the MCU into which the image 20 has been divided as shown in FIG. 6. The MCU contains first luminance data Y1, second luminance data Y2, third luminance data Y3, fourth luminance data Y4 and color difference data Cb and Cr. The first luminance data Y1 represents luminance data within an upper-left area among four areas obtained by dividing the MCU in half both horizontally and vertically. The second luminance data Y2, third luminance data Y3 and fourth luminance data Y4 represent luminance data within upper-right, lower-left and lower-right areas, respectively, among the four areas. The color difference data Cb and Cr represents the Cb and Cr of the MCU (namely 4:2:0 components).

When the image is divided into the plurality of MCUs, the MCUs are read out in order. It is determined whether an MCU that has been read out is an MCU into which an RST (restart) marker is to be inserted (step 34). In this embodiment, an RST marker is inserted into every 10 MCUs. Naturally, an RST marker may be inserted into each MCU or into MCUs of every other row. Preferably, a plurality of RST markers are inserted every one or plurality of MCUs in one row, and these RST markers are inserted into MCUs in the same columns.

If an MCU that has been read is a unit into which an RST marker is to be inserted (“YES” at step 34), then an RST marker is inserted into this read MCU (step 35). If an MCU that has been read is a unit into which an RST marker is not to be inserted (“NO” at step 34), then the processing of step 35 is skipped.

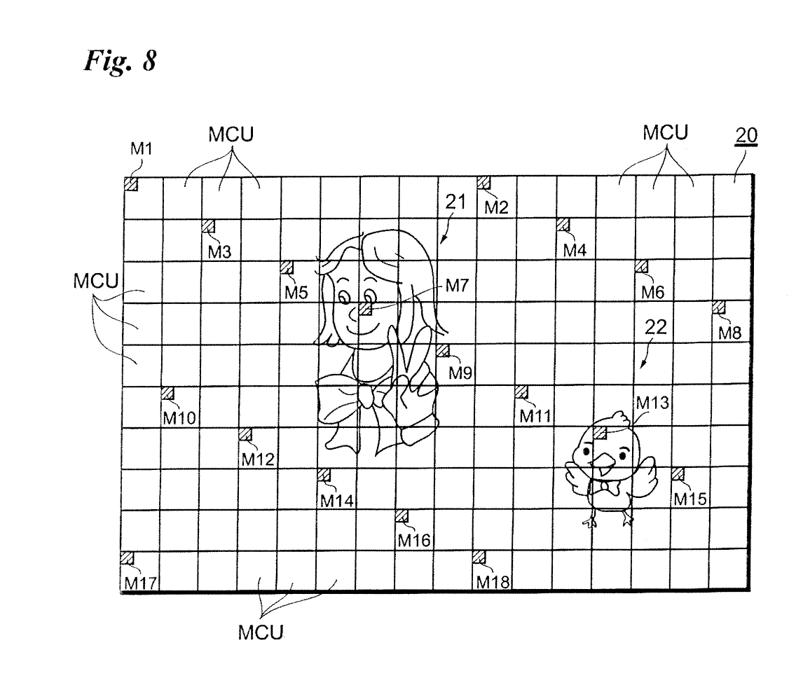

FIG. 8 illustrates an example of an image into which RST markers have been inserted. As mentioned above, RST markers are inserted every 10 MCUs if MCUs start being counted in the rightward direction starting from the uppermost row and, when there are no longer any MCUs on the rightmost side of each row, counting continues upon shifting to the next row. In this embodiment, a total of 18 RST markers M1 to M18 are inserted into the image 20, as indicated by the hatching. The RST markers M1 to M18 are inserted into the respective MCUs at the leading (or trailing) edge thereof.

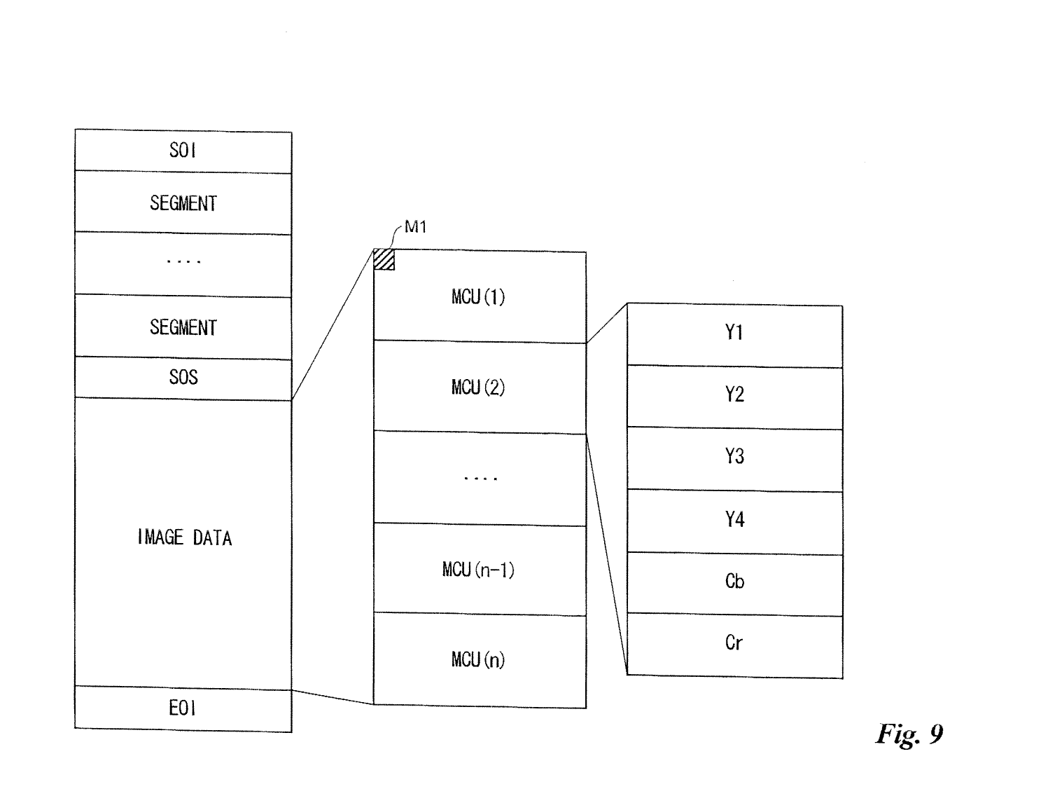

FIG. 9 is an example of a file structure illustrating the manner in which an RST marker has been inserted into an MCU. The RST marker is inserted every 10 MCUs, as mentioned above. FIG. 9 shows the manner in which RST marker M1 has been inserted into the initial MCU.

Next, a DCT (Direct Cosine Transform) is applied to the image data (the first luminance data Y1, second luminance data Y2, third luminance data Y3, fourth luminance data Y4 and color difference data Cb and Cr) that constitutes the read MCU (step 36). As a result of the DCT, 64 DCT coefficients are obtained with regard to each of the items of first luminance data Y1, second luminance data Y2, third luminance data Y3, fourth luminance data Y4 and color difference data Cb and Cr.

FIG. 10 is an example of the file structure and illustrates the manner in which the DCT coefficients have been stored in the file.

Since the first luminance data Y1, second luminance data Y2, third luminance data Y3 and fourth luminance data Y4 represent respective ones of the four areas into which a 16×16 pixel MCU has been divided, the items of first luminance data Y1, second luminance data Y2, third luminance data Y3 and fourth luminance data Y4 represent respective ones of 8×8 pixel (=64 pixel) portions. A DCT coefficient is obtained in correspondence with each pixel of these 64 pixels. With regard to the color difference data Cb and Cr, a DCT coefficient is obtained in correspondence with each pixel of 64 pixels obtained by sampling 16×16 pixels at 8×8 pixels. In FIG. 10, the fact that DCT coefficients have been stored is represented only with regard to the second luminance data Y2. However, DCT coefficients have been stored not only for the second luminance data Y2 but also for the other luminance data Y1, Y3 and Y4 and for the color difference data Cb and Cr.

When execution of the DCT ends with regard to the read MCU, Huffman coding is executed with regard to this MCU (step 37). It goes without saying that quantization, rearranging of the DCT coefficients in order of increasing frequency and zigzag scanning are carried out as necessary. Since compression utilizing these DCT coefficients is well known, no further description thereof is given here.

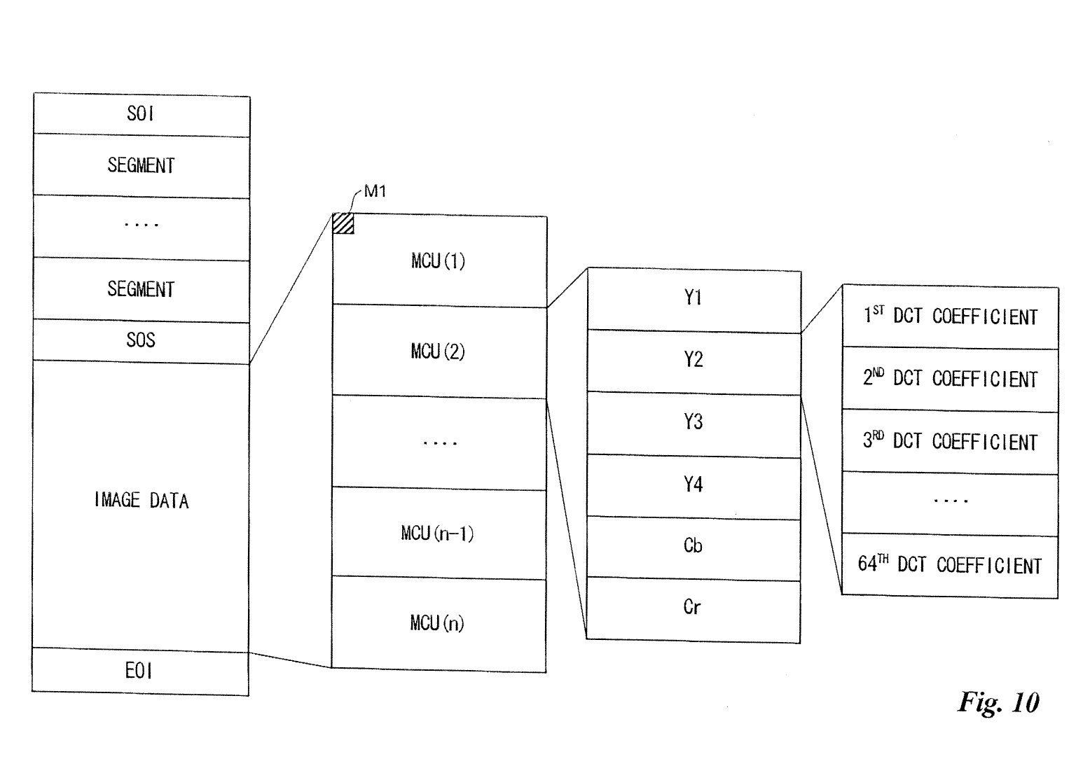

FIG. 11 illustrates the corresponding relationship between OCT coefficients and Huffman codes. A Huffman code has been assigned to every OCT coefficient. For example, if the DCT coefficients are “0”, “1”, “2” and “3”, then the Huffman codes “0”, “10”, “110” and “1110”, respectively. Further, in this embodiment, a Huffman code has been assigned to the RST marker and the value of this Huffman code is “11111”. It goes without saying that these codes have been simplified in order to facilitate understanding. Converting OCT coefficients to Huffman codes that correspond to the respective OCT coefficients is the essence of Huffman coding.

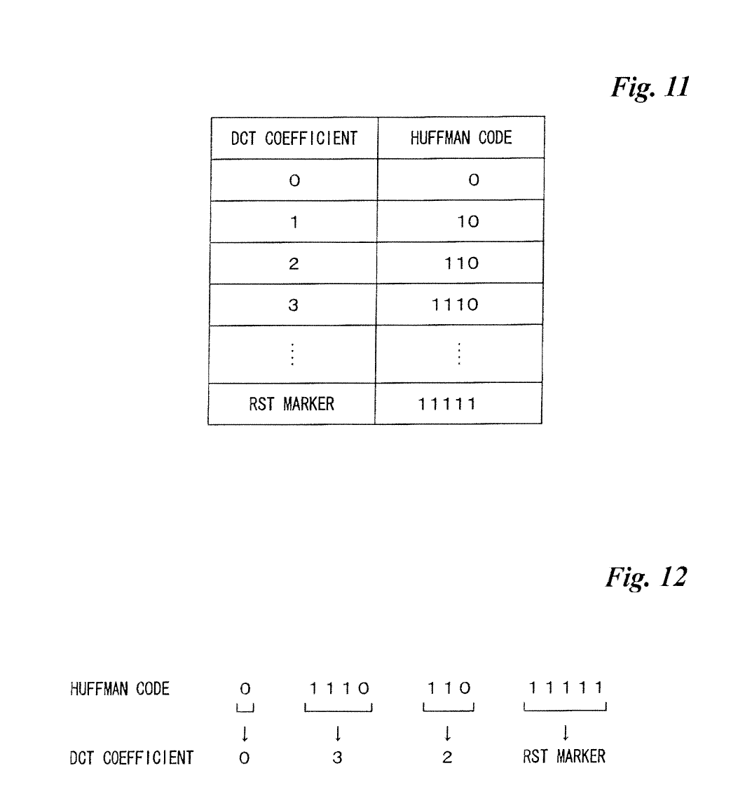

FIG. 12 illustrates the manner in which Huffman codes are decoded into DCT coefficients.

Huffman codes can be decoded (Huffman-decoded) into OCT coefficients from the corresponding relationship between DCT coefficients and Huffman codes shown in FIG. 11. For example, the data sequence of the Huffman codes shown in FIG. 12 0111011011111. If the Huffman codes are “0”, “10”, “110”, “1110” and “11111”, then the respective OCT coefficients or RST marker are “0”, “1”, “2”, “3” and the RST marker. The data sequence of the Huffman codes shown in FIG. 12 is “0”, “3”, “2”, “RST marker”.

Since a Huffman code is a variable-length code, the amount of data varies depending upon the value of the OCT coefficient. As a consequence, unless the decoding of the entire MCU is finished, one cannot ascertained what the extent of the code representing the image data of this MCU is. In this embodiment, the RST marker has been inserted into MCUs at prescribed intervals (periodically). By finding the Huffman codes of the RST markers, therefore, the delimiting boundaries of the MCUs can be ascertained. For example, if the Huffman code “11111” is found, it can determined that this is an RST marker even without decoding the Huffman code, and it can be ascertained that the image data of the MCU starts from this RST marker. In particular, the RST marker has been inserted in MCUs every 10 MCUs. Therefore, even in a case where the Huffman codes have been read in order starting from the beginning, counting the number of times the Huffman-coded RST markers appear will make it possible to ascertain the MCUs of that particular portion of the image whose Huffman codes representing the data of these MCUs have been read.

The above-described compression processing is repeated with regard to all of the MCUs (step 38).

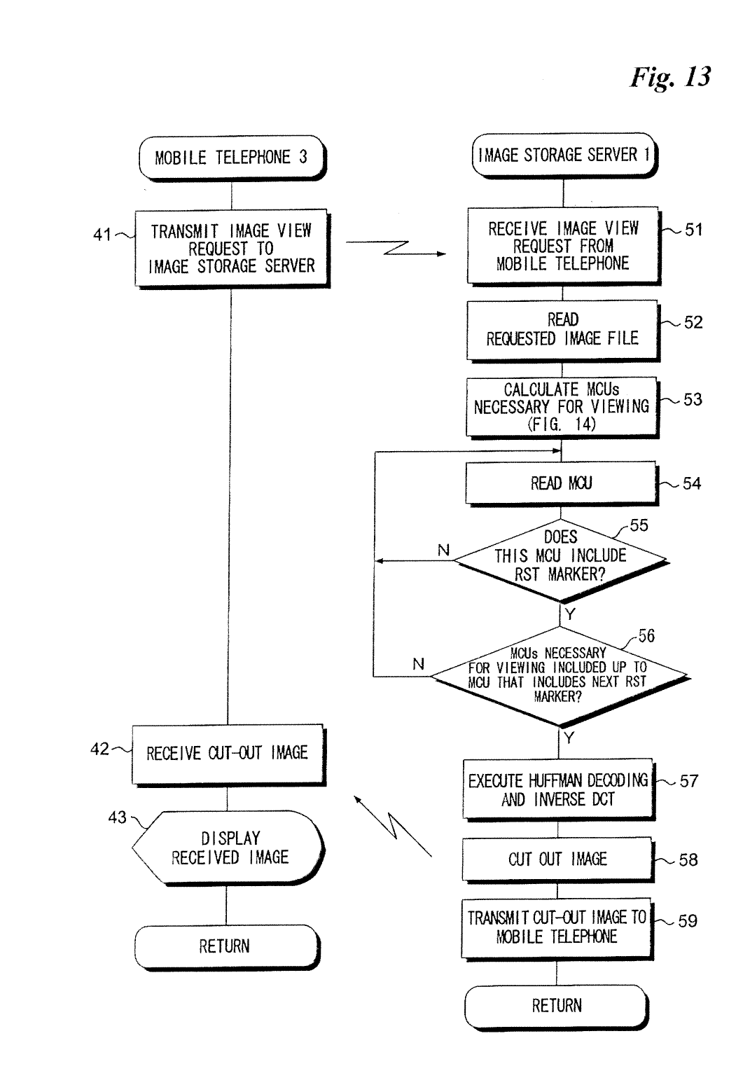

FIG. 13 is a flowchart illustrating processing for viewing an image represented by image data that has been compressed in the manner described above. In this embodiment, the mobile telephone 3 and the image storage server 1 communicate directly. However, it goes without saying that the mobile telephone 3 and image storage server 1 communicate via the image transmission server 2, as described above. The mobile telephone 3 and image storage server 1 may communicate without the intermediary of the image transmission server 2, as a matter of course. Further, image data expansion processing described later may be executed by the image transmission server 2 or mobile telephone 3 without the mobile telephone 3 necessarily communicating with the image storage server 1 or image transmission server 2.

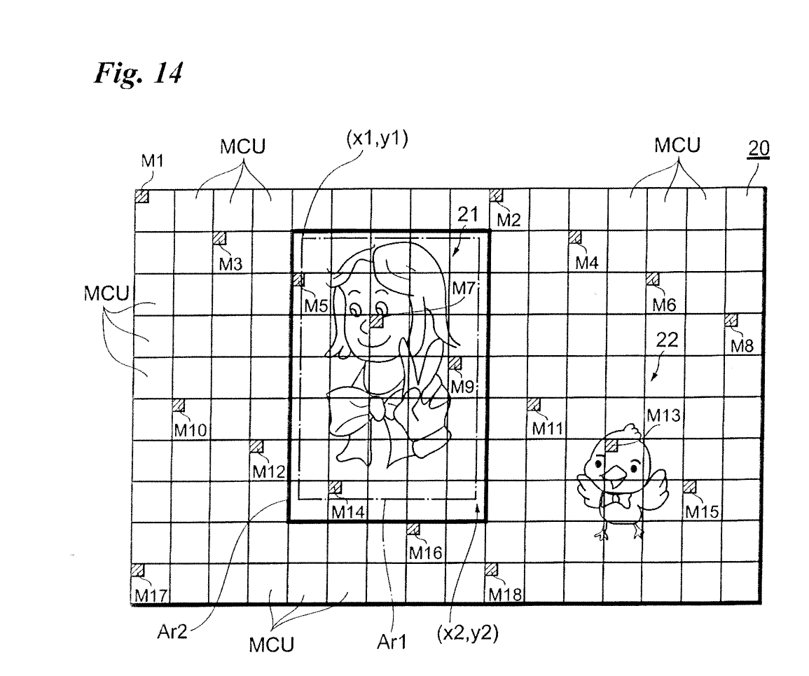

FIG. 14 is an example of image 20.

In order to facilitate understanding, FIG. 14 has been divided into a plurality of MCUs in a manner similar to that shown in FIG. 8, and RST markers are illustrated at M1 to M20.

It is assumed here that the image 20 shown in FIG. 3 is already being displayed at a low resolution on the mobile telephone 3, and that an image portion (area Ar1 indicated by the broken line in FIG. 14), which is one part of the image 20, is requested. The image portion of this one part of the image will be displayed over the entire display screen of the mobile telephone 3 in a manner described later.

The area Ar1, which encloses the subject image 21, is designated in the image 20 by using the mobile telephone 3. Assume that the area Ar1 is a rectangular area the upper left of which has coordinates (x1,y1) and the lower right of which has coordinates (x2,y2).

With reference to FIG. 13, an image view request is transmitted from the mobile telephone 3 to the image storage server 1 (step 41). The image view request includes the data of the coordinates that specify the area Ar1, as mentioned above, in addition to data specifying the image. It will be assumed that the image shown in FIG. 3 has been requested, as set forth above.

When the image view request transmitted from the mobile telephone 3 is received by the image storage server 1 (step 51), the requested image file is read from the hard disk 1a (step 52). Next, the MCUs necessary for viewing the image are calculated (step 53).

Assume that the area Ar1 has been designated, as shown in FIG. 14. In order to view the image within the area Ar1, the MCUs necessary will be the 21^{st} to the 25^{th}, the 37^{th} to the 41^{st}, the 53^{rd} to the 57^{th}, the 69^{th} to the 73^{rd}, the 85^{th} to the 89^{th}, the 101^{st} to the 105^{th} and the 117^{th} to the 121^{st} in a case where the MCUs are counted rightward from the upper left and downward in order.

One MCU of Huffman code data is read (step 54) and whether this read Huffman code data includes an RST marker is determined (step 55). As mentioned above,

Huffman-coded data has been stored in the image file and whether this is an RST marker can be ascertained without Huffman decoding. If the data does not include an RST marker (“NO” at step 55), the Huffman code data of the next MCU is read from the image file.

If the read one MCU of Huffman code data includes an RST marker (“YES” at step 55), it is determined whether MCUs necessary for viewing are included up to the MCU that includes the next RST marker (step 56). If such MCUs are not included (“NO” at step 56), then the next one MCU of Huffman code data is read.

If MCUs necessary for viewing are included up to the MCU that includes the next RST marker (“YES” at step 56), then Huffman decoding is applied to the one MCU of Huffman code data that has been read. Furthermore, an inverse DCT is applied to the Huffman-decoded data (step 57). Since the RST markers have been inserted in MCUs periodically every 10 MCUs, whether or not MCUs necessary for viewing are included up to the MCU that includes the next RST marker can be ascertained if the number of times the RST markers appear is counted and the counted number of times is compared with the MCUs necessary for viewing that have been calculated. For example, it can be ascertained that MCUs necessary for viewing are included in the MCUs from the third RST marker M3 to the fourth RST marker M4.

Thus, the Huffman code data of the MCUs from the third RST marker M3 to the ninth RST marker M9, from the 10th RST marker M10 to the 11th RST marker M11 and from the 12th RST marker M12 to the 15th RST marker M15 is decoded and subjected to an inverse DCT. Huffman decoding and an inverse DCT are not applied to the MCUs from the first RST marker M1 to the third RST marker M3, from the 11th RST marker M11 to the 12th RST marker M12 and from the 15th RST marker M15 onward.

The image inside an area Ar2 that encloses the area Ar1 indicated by the broken line is obtained. The image indicated by the area Ar1 is cut from the image of area Ar2 (step 58). The image data representing the image that has been cut out is transmitted from the image storage server 1 to the mobile telephone 3 (step 59).

When the image data transmitted from the image storage server 1 is received by the mobile telephone 3 (step 42), the image within the area Ar1 is displayed on the display screen of the mobile telephone 3 (step 43). Since the entirety of the image 20 is not subjected to Huffman decoding and an inverse DCT, the image can be displayed promptly.

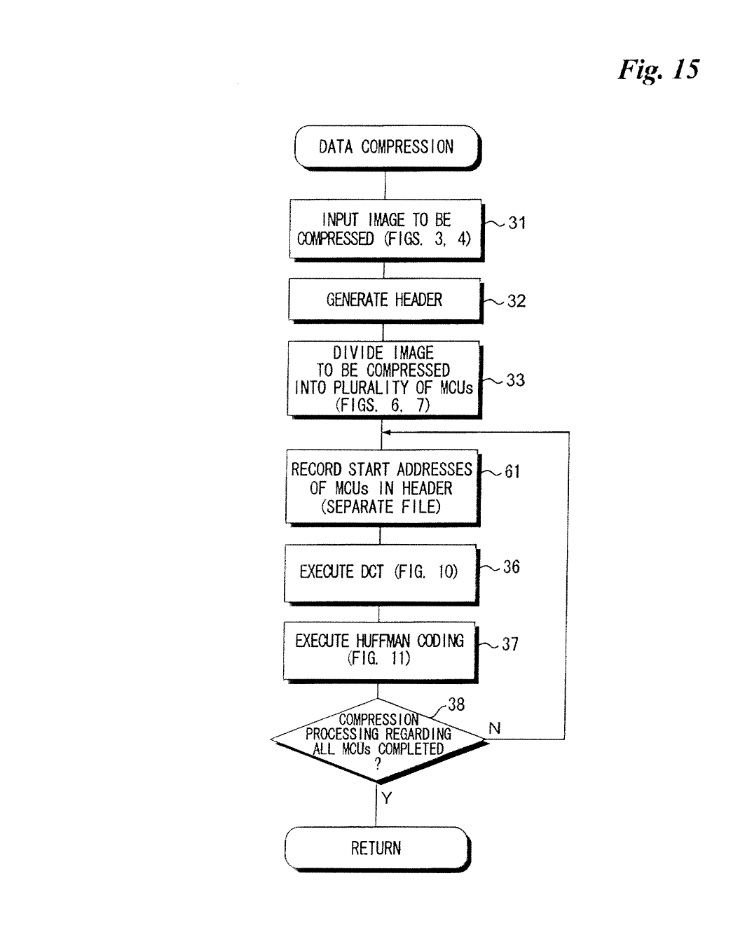

FIGS. 15 to 17 illustrate another embodiment.

In the above-described embodiment, RST markers have been inserted into MCUs. In this embodiment, however, the start addresses of MCUs are recorded.

FIG. 15, which is a flowchart illustrating image data compression processing, corresponds to the processing shown in FIG. 5. Processing steps in FIG. 15 identical with those shown in FIG. 5 are identified by like step numbers and need not be described again.

An image to be compressed is divided into a plurality of MCUs (step 33), as described earlier. The start address of each MPU is then recorded in the header of the image file (step 61). It may be so arranged that the start address is recorded in a file separate from the image file in which the image data representing the image to be compressed has been stored. Naturally, the image file storing the image data representing the image to be compressed and the file storing the start addresses would need to be correlated, as by adopting file names that have portions in common.

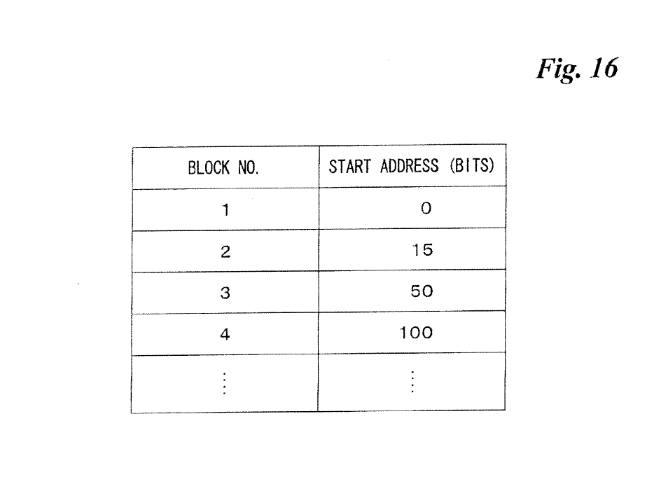

FIG. 16 illustrates the corresponding relationship between MCU numbers and the start addresses of MCUs identified by these numbers. Data indicating this corresponding relationship is stored in the header or in a separate file, as mentioned above.

The start address of an MCU having a unit number is represented by the bit number from the beginning of the image. Huffman code data of the MCU of Unit No. 1 starts from the 0^{th} bit, and Huffman code data of the MCU of Unit. No. 2 starts from the 15^{th} bit. The same holds true for the Huffman code data regarding the other MCUs.

It may be so arranged that the start addresses regarding every few MCUs or any desired MCUs may be stored instead of storing the start addresses regarding all of the MCUs.

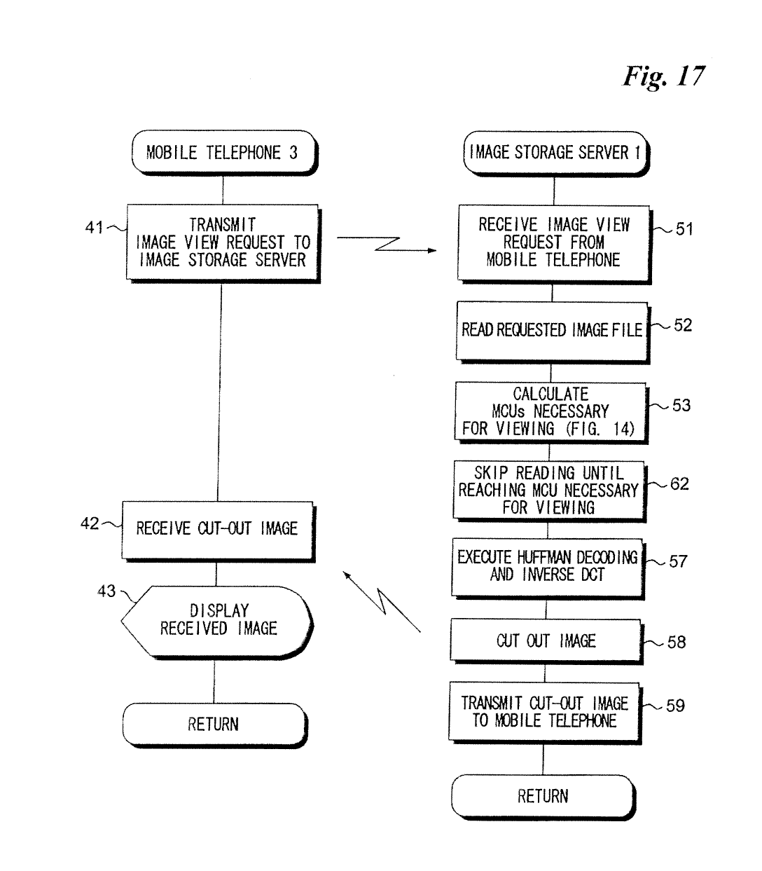

FIG. 17, which is a flowchart illustrating processing for viewing an image, corresponds to the processing shown in FIG. 13. Processing steps in FIG. 17 identical with those shown in FIG. 13 are identified by like step numbers and need not be described again.

When the MCUs necessary for viewing are calculated, as mentioned above, the reading of encoded data is skipped until encoded data at the head of MCUs necessary for viewing is reached (step 62). Huffman decoding and an inverse DCT are applied to encoded data of MCUs necessary for viewing (step 57). The desired portion of the image is displayed on the display screen of the mobile telephone 3 (step 43) in the manner described earlier.

As many apparently widely different embodiments of the present invention can be made without departing from the spirit and scope thereof, it is to be understood that the invention is not limited to the specific embodiments thereof except as defined in the appended claims.

What is claimed is:

1. An image data compression apparatus comprising:
a designating device for designating a portion of an image, which is to be extracted, from within an original image;
a compressed image data reading device for reading compressed image data from a recording medium on which the compressed image data has been recorded, the compressed image data having been obtained by dividing original image data representing the original image into a plurality of units, inserting identification data into any units of the plurality of units and compressing, on a per-unit basis, the original data of any units of the units into which the identification data has been inserted and units into which the identification data has not been inserted, the compressed image data being read from the recording medium on a per-unit basis in accordance with a certain order;
a first determination device for determining, based upon the image of the portion designated by said designating device, whether a unit of compressed image data that has been read by said compressed image data reading device contains the identification data;
a second determination device for determining whether the image of the portion designated by said designating device is included between a unit determined by said first determination device to contain the identification data and a unit that contains the next identification data; and
an expanding device, responsive to a determination by said second determination device that the image of the portion designated by said designating device is included between a unit determined by said first determination device to contain the identification data and a unit that contains the next identification data, for expanding compressed image data which extends from the unit of compressed image data that has been read by said compressed image data reading device to the unit that contains the next identification data.

2. The apparatus according to claim 1, wherein the identification data is an RST marker.

3. An image data compression apparatus comprising:
a unit dividing device for dividing original image data representing one frame of an original image into a plurality of units;
an identification data insertion determination device for determining whether to insert identification data into one unit among the plurality of units obtained by division by said unit dividing device;
an identification data inserting device, responsive to a determination by said identification data insertion determining device of a unit into which identification data is to be inserted, for inserting the identification data into the unit determined;
a compressing device for compressing original image data of the unit into which identification data has been inserted by said identification data inserting device or of a unit determined by said identification data insertion determination device to be one into which identification data is not to be inserted;
a control device for exercising control in such a manner that operations performed by said identification data insertion determination device, said identification data inserting device and said compressing device are repeated; and
a recording control device for recording image data, which has been compressed by said compressing device, on a recording medium.

4. The apparatus according to claim 3, wherein said compressing device includes:
an orthogonal transform device for applying an orthogonal transform to image data of a unit into which identification data has been inserted by said identification data inserting device or of a unit determined by said identification data insertion determination device to be one into which identification data is not to be inserted, and obtaining orthogonal transform coefficients; and
an encoding device for assigning a prescribed code to each of the orthogonal transform coefficients obtained by said orthogonal transform device and obtaining encoded data.

5. An image data expansion apparatus comprising:
a designating device for designating a portion of an image, which is to be extracted, from within an original image;
a compressed image data reading device for reading compressed image data from a recording medium on which the compressed image data has been recorded, the compressed image data having been obtained by dividing original image data representing the original image into a plurality of units and compressing the original image data on a per-unit basis, address data indicating a start address of each unit of the plurality of units also having been recorded on the recording medium, the compressed image data being read from the recording medium on a per-unit basis;
an address data reading device for reading the address data from the recording medium;
a determination device for determining, based upon the portion of the image designated by said designating device and the address data read by said address data reading device, whether the portion of the image designated by said designating device is included between a unit of compressed image data that has been read by said compressed image data reading device and the next unit; and
an expanding device, responsive to a determination by said determination device that the portion of the image designated by said designating device is included between a unit of compressed image data that has been read by said compressed image data reading device and the next unit, for expanding compressed image data which extends from the unit of compressed image data that has been read by said compressed image data reading device to the next unit.

6. An image data compression apparatus comprising:
a unit dividing device for dividing original image data representing one frame of an original image into a plurality of units;
a compressing device for compressing one frame of original image data of each unit among the plurality of units obtained by division by said unit dividing device; and
a recording control device for recording address data indicating a start address of any unit among the plurality of units obtained by division by said unit dividing device, as well as image data compressed by said compressing device, on a recording medium.

7. The apparatus according to claim 6, wherein said compressing device includes:
an orthogonal transform device for applying an orthogonal transform to original image data of each unit and obtaining orthogonal transform coefficients; and
an encoding device for assigning a prescribed code to each of the orthogonal transform coefficients obtained by said orthogonal transform device and obtaining encoded data.

8. A method of controlling operation of an image data expansion apparatus, comprising the steps of:
designating a portion of an image, which is to be extracted, from within an original image;
reading compressed image data from a recording medium on which the compressed image data has been recorded, the compressed image data having been obtained by dividing original image data representing the original image into a plurality of units, inserting identification data into any unit of the plurality of units and compressing, on a per-unit basis, the original data of any units of the units into which the identification data has been inserted and units into which the identification data has not been inserted, the compressed image data being read from the recording medium on a per-unit basis in accordance with a certain order;
determining, based upon the portion of the image designated, whether a unit of compressed image data that has been read contains identification data;
determining whether the portion of the image designated is included between a unit determined to contain identification data and a unit that contains the next identification data; and
in response to a determination that the portion of the image designated is included between a unit determined to contain identification data and a unit that contains the next identification data, expanding the compressed image data from the unit of compressed image data that has been read to the unit that contains the next identification data.

9. A method of controlling operation of an image data compression apparatus, comprising the steps of:
dividing original image data representing one frame of an original image into a plurality of units;
determining whether to insert identification data into one unit among the plurality of units obtained by division;
in response to determination of a unit into which identification data is to be inserted, inserting the identification data into the unit determined;
compressing original image data of the unit into which identification data has been inserted or of a unit determined to be one into which identification data is not to be inserted;
exercising control in such a manner that operations performed by the identification data insertion determination processing, identification data inserting processing and compressing processing are repeated; and
recording compressed image data on a recording medium.

10. A method of controlling operation of an image data expansion apparatus, comprising the steps of:
designating a portion of an image, which is to be extracted, from within an original image;
reading compressed image data from a recording medium on which the compressed image data has been recorded, the compressed image data having been obtained by dividing original image data representing the original image into a plurality of units and compressing the original image data on a per-unit basis, address data indicating a start address of each unit of the plurality of units also having been recorded on the recording medium, the compressed image data being read from the recording medium on a per-unit basis;
reading the address data from the recording medium;
determining, based upon the portion of the image designated and the address data read, whether the portion of the image designated is included between a unit of compressed image data that has been read and the next unit; and
in response to a determination that the portion of the image designated is included between a unit of compressed image data that has been read and the next unit, expanding compressed image data which extends from the unit of compressed image data that has been read to the next unit.

11. A method of controlling operation of an image data compression apparatus, comprising the steps of:
dividing original image data representing one frame of an original image into a plurality of units;
compressing one frame of original image data of each unit among the plurality of units obtained by division; and
recording address data indicating a start address of any unit among the plurality of units obtained by division, as well as compressed image data, on a recording medium.

12. A recording medium storing a computer-readable program for controlling a computer of an image data expansion apparatus so as to:
designate a portion of an image, which is to be extracted, from within an original image;
read compressed image data from a recording medium on which the compressed image data has been recorded, the compressed image data having been obtained by dividing original image data representing the original image into a plurality of units, inserting identification data into any unit of the plurality of units and compressing, on a per-unit basis, the original data of any units of the units into which the identification data has been inserted and units into which the identification data has not been inserted, the compressed image data being read from the recording medium on a per-unit basis in accordance with a certain order;
determine, based upon the portion of the image designated, whether a unit of compressed image data that has been read contains identification data;
determine whether the portion of the image designated is included between a unit determined to contain identification data and a unit that contains the next identification data; and
in response to a determination that the portion of the image designated is included between a unit determined to contain identification data and a unit that contains the next identification data, expand the compressed image data from the unit of compressed image data that has been read to the unit that contains the next identification data.

13. A recording medium storing a computer-readable program for controlling a computer of an image data compression apparatus so as to:
divide original image data representing one frame of an original image into a plurality of units;
determine whether to insert identification data into one unit among the plurality of units obtained by division;
in response to determination of a unit into which identification data is to be inserted, insert the identification data into the unit determined;
compress original image data of the unit into which identification data has been inserted or of a unit determined to be one into which identification data is not to be inserted;
exercise control so as to repeat processing for determining whether to insert the identification data, processing for inserting the identification data and processing for compressing the data; and
record compressed image data on a recording medium.

14. A recording medium storing a computer-readable program for controlling a computer of an image data expansion apparatus so as to:
designate a portion of an image, which is to be extracted, from within an original image;
read compressed image data from a recording medium on which the compressed image data has been recorded, the compressed image data having been obtained by dividing original image data representing the original image into a plurality of units and compressing the original image data on a per-unit basis, address data indicating a start address of each unit of the plurality of units also having been recorded on the recording medium, the compressed image data being read from the recording medium on a per-unit basis;
read the address data from the recording medium;
determine, based upon the portion of the image designated and the address data read, whether the portion of the image designated is included between a unit of compressed image data that has been read and the next unit; and
in response to a determination that the portion of the image designated is included between a unit of compressed image data that has been read and the next unit, expand compressed image data which extends from the unit of compressed image data that has been read to the next unit.

15. A recording medium storing a computer-readable program for controlling a computer of an image data compression apparatus so as to:
divide original image data representing one frame of an original image into a plurality of units;
compress one frame of original image data of each unit among the plurality of units obtained by division; and
record address data indicating a start address of any unit among the plurality of units obtained by division, as well as compressed image data, on a recording medium.
